(19) United States
(12) Patent Application Publication
(10) Pub. No.: US 2026/0023337 A1
(43) Pub. Date: Jan. 22, 2026

(54) TONER CARTRIDGE

(71) Applicant: CANON KABUSHIKI KAISHA, Tokyo (JP)

(72) Inventor: TATSURO HARADA, Shizuoka (JP)

(21) Appl. No.: 19/267,386

(22) Filed: Jul. 11, 2025

(30) Foreign Application Priority Data
Jul. 16, 2024 (JP) 2024-113440

(51) Int. Cl. G03G 15/08; G03G 21/20

(52) U.S. Cl. CPC G03G 15/0877; G03G 15/0875; G03G 21/206; G03G 2215/068; G03G 2215/0869

(57) ABSTRACT

A toner cartridge includes a first frame with a port to receive external air; a second frame forming a space together with the first frame; and a sheet-like filter to partition the space into an air chamber and a toner storage chamber, and to regulate toner flow while allowing air passage. The air chamber communicates with the port without the filter, and the toner storage chamber communicates with the port through the filter. The filter includes a first surface facing the air chamber, a second surface facing the toner storage chamber, and a third surface extending in the filter's thickness direction, and at least a part of the third surface is adhered to the first frame with an adhesive to be fixed.

### BACKGROUND

### Field of the Technology

The present disclosure relates to a toner cartridge and a process cartridge for an electrophotographic type image forming apparatus, and an image forming apparatus that uses these cartridges.

### Description of the Related Art

In electrophotographic type image forming apparatuses, a configuration is widely known in which a toner cartridge that stores toner to be used for image formation and a process cartridge for performing an electrophotographic process are detachably mountable to an apparatus main body. In such a toner cartridge, for example, as discussed in Japanese Patent No. 4678735, a configuration is used in which toner is conveyed using air, using both a pump that discharges air and a pump that sucks toner and air.

### SUMMARY

An aspect of the present disclosure provides a toner cartridge that includes a first frame provided with a receiving port configured to receive air from outside the toner cartridge; a second frame; a space between the first frame and the second frame; and a filter configured to partition the space into an air chamber and a toner storage chamber that stores toner, and to regulate passage of toner while allowing passage of the air. The air chamber communicates with the receiving port without interposition of the filter. The toner storage chamber communicates with the receiving port through the filter. The filter includes a first surface that faces the air chamber, a second surface that faces the toner storage chamber, and a third surface that extends in a thickness direction of the filter and connects the first surface and the second surface. At least a part of the third surface is adhered to the first frame with an adhesive.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming apparatus according to a first exemplary embodiment.

FIG. 2 is a cross-sectional view of a process cartridge and a toner cartridge according to the first exemplary embodiment.

FIGS. 3A and 3B are cross-sectional views of the toner cartridge according to the first exemplary embodiment.

FIG. 4 is a cross-sectional perspective view of the toner cartridge according to the first exemplary embodiment.

FIG. 5 is an exploded cross-sectional perspective view of the toner cartridge according to the first exemplary embodiment.

FIG. 6 is a perspective view of a ventilation member according to the first exemplary embodiment.

FIGS. 7A, 7B, and 7C are cross-sectional views of the toner cartridge according to the first exemplary embodiment.

FIGS. 8A and 8B are cross-sectional views of the toner cartridge according to the first exemplary embodiment.

FIG. 9 is a cross-sectional view of the toner cartridge according to the first exemplary embodiment.

FIG. 10 is a cross-sectional view of the toner cartridge according to the first exemplary embodiment.

FIG. 11 is a cross-sectional view of the toner cartridge according to the first exemplary embodiment.

FIGS. 12A and 12B are cross-sectional views of a toner cartridge according to a second exemplary embodiment.

FIG. 13 is a cross-sectional perspective view of a ventilation member according to a third exemplary embodiment.

FIGS. 14A and 14B are cross-sectional views of a toner cartridge according to the third exemplary embodiment.

FIGS. 15A and 15B are cross-sectional views of the toner cartridge according to the first exemplary embodiment.

FIGS. 16A and 16B are cross-sectional views of the toner cartridge according to the third exemplary embodiment.

### DESCRIPTION OF THE EMBODIMENTS

Exemplary embodiments for carrying out the present disclosure will be described below with reference to the attached drawings.

Examples of an image forming apparatus described below include a copy machine, a printer, a multifunction peripheral, and a commercial printing apparatus. An image forming apparatus forms an image on a recording medium based on image information input from an external computer and image information read from a document. As recording media, sheet materials of various materials and shapes are used, including paper such as plain paper and thick paper, plastic films, coated paper, sheets having special shapes such as envelopes and index paper, and cloth.

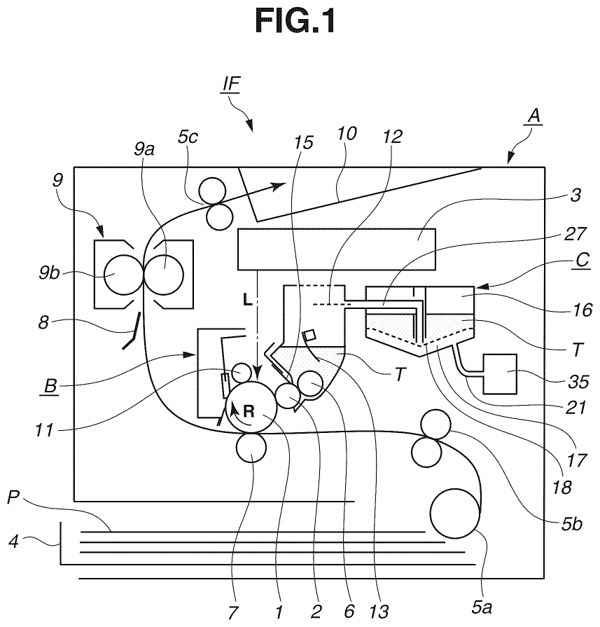

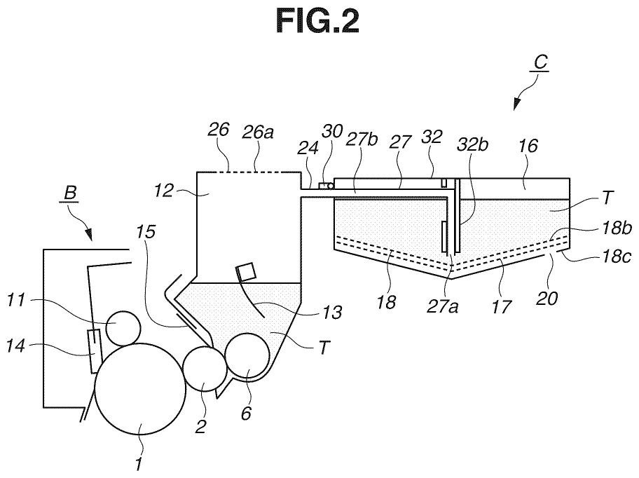

FIG. 1 is a schematic drawing illustrating a cross-sectional configuration of an image forming apparatus IF according to a first exemplary embodiment of the present disclosure. FIG. 2 is a cross-sectional view of a process cartridge B and a toner cartridge C. As illustrated in FIG. 1, the process cartridge B and the toner cartridge C are mounted to an apparatus main body A of the image forming apparatus IF and form an image on a sheet P, which is a recording medium. The apparatus main body A is a part of the image forming apparatus IF excluding the process cartridge B and the toner cartridge C.

### (Overall Configuration of Image Forming Apparatus)

As illustrated in FIG. 1, the image forming apparatus IF according to the present exemplary embodiment is an electrophotographic type laser beam printer that forms an electrostatic latent image on a surface of a photosensitive drum 1 using a laser beam L emitted from a laser scanner 3 serving as an exposure unit and transfers the image developed using toner T as a developer to the sheet P. In addition to the process cartridge B and the toner cartridge C, the apparatus main body A includes a pickup roller 5a, a conveyance roller pair 5b, a transfer roller 7, a fixing apparatus 9, a discharge roller pair 5c, and a discharge tray 10 in a direction in which the sheet P is conveyed from a sheet tray 4.

The process cartridge B includes the photosensitive drum 1 serving as a photosensitive member, a developing roller 2 serving as a developer carrying member, a charging roller 11 serving as a charging unit, and a toner chamber 12 that stores the toner T to be supplied to the developing roller 2. The toner cartridge C stores the toner T to be supplied to the toner chamber 12 of the process cartridge B.

The charging roller 11 that performs charging processing, the developing roller 2 that performs developing processing, and the transfer roller 7 that performs transfer processing are all examples of process units that act on the photosensitive drum 1 in an electrophotographic process.

### (Image Forming Process)

When the image forming apparatus IF receives a signal for starting image formation with respect to the sheet P, the photosensitive drum 1 is driven to rotate in a direction of an arrow R in FIG. 1. The charging roller 11 comes into contact with an outer peripheral surface of the photosensitive drum 1 and uniformly and evenly charges the surface of the drum. The laser scanner 3 irradiates the photosensitive drum 1 with the laser beam L based on image information and writes an electrostatic latent image on the surface of the drum.

The toner T stored in the toner chamber 12 is delivered toward a sponge-like developer supply roller 6 by a stirring member 13. Then, the toner T is supplied to the developing roller 2 by the developer supply roller 6 and is carried as a thin layer on a surface of the developing roller 2 by a developing blade 15. The toner T that has reached a developing area in which the developing roller 2 and the photosensitive drum 1 face each other is transferred from the developing roller 2 to the surface of the photosensitive drum 1 according to a potential distribution on the surface of the photosensitive drum 1. Accordingly, the electrostatic latent image on the surface of the drum is visualized as a toner image.

In parallel with the above-described process, the sheet P is fed at a timing in synchronization with an exposure operation by the laser scanner 3. The pickup roller 5a illustrated in FIG. 1 sends out the sheet P stacked on the sheet tray 4 therefrom. The conveyance roller pair 5b receives the sheet P from the pickup roller 5a and conveys the sheet P to a transfer portion between the photosensitive drum 1 and the transfer roller 7. Then, a bias voltage is applied to the transfer roller 7, and thus the toner image carried by the photosensitive drum 1 is transferred to the sheet P.

The sheet P to which the toner image is transferred is conveyed along a conveyance guide 8 to the fixing apparatus 9. The fixing apparatus 9 applies heat and pressure to the toner image on the sheet P using a heating roller 9a and a pressure roller 9b to fix the image to the sheet P. The sheet P subjected to image fixing processing is discharged by the discharge roller pair 5c to the discharge tray 10 provided in an upper portion of the apparatus main body A.

### (Process Cartridge)

Next, an outline of a configuration of the process cartridge B is described with reference to FIG. 2.

The process cartridge B according to the present exemplary embodiment is configured to be detachably mountable to the apparatus main body A. The process cartridge B includes the charging roller 11 and a cleaning blade 14 around the photosensitive drum 1. The process cartridge B further includes the developing roller 2, the developing blade 15, the developer supply roller 6, the toner chamber 12 that stores the toner T to be supplied to the developing roller 2, and the stirring member 13 that stirs the toner T as developing units. Furthermore, the process cartridge B includes a receiving port 24 that receives the toner T supplied from the toner cartridge C, and an exhaust portion 26 through which air in the toner chamber 12 passes and being disposed on an upper surface of the toner chamber 12, and a filter 26a serving as a ventilation member on an upper surface of the exhaust portion 26.

### (Description of Each Unit in Toner Cartridge)

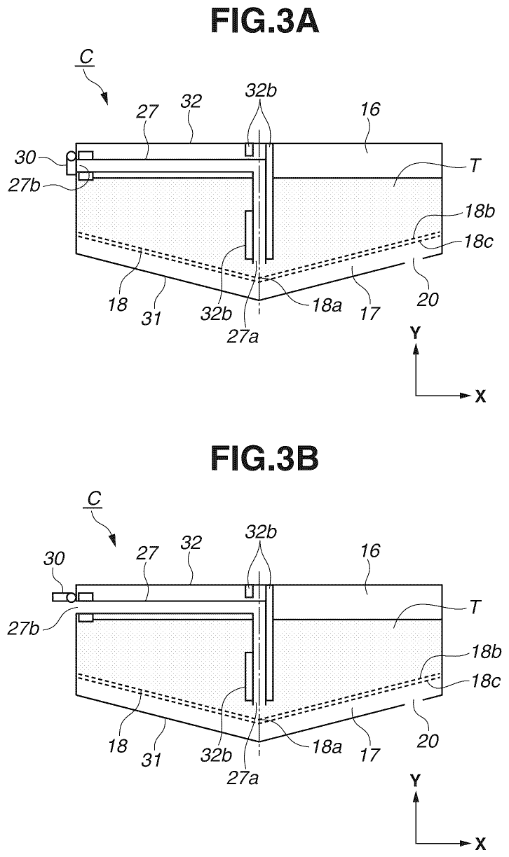

An outline of an overall configuration of the toner cartridge C is described, and then each unit is described. The outline of the configuration of the toner cartridge C is described with reference to FIGS. 3A to 6.

FIGS. 3A and 3B are cross-sectional views of the toner cartridge C. FIG. 3A illustrates a state in which a sealing member 30 seals a discharging port 27b, and FIG. 3B illustrates a state in which the sealing member 30 is opened.

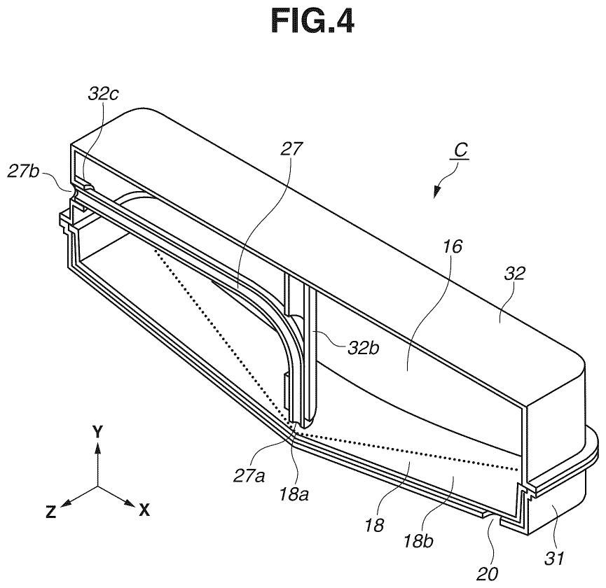

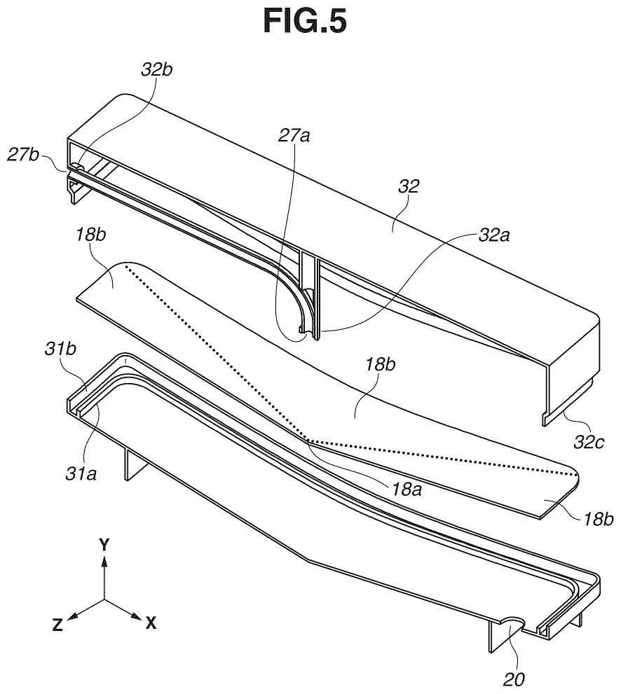

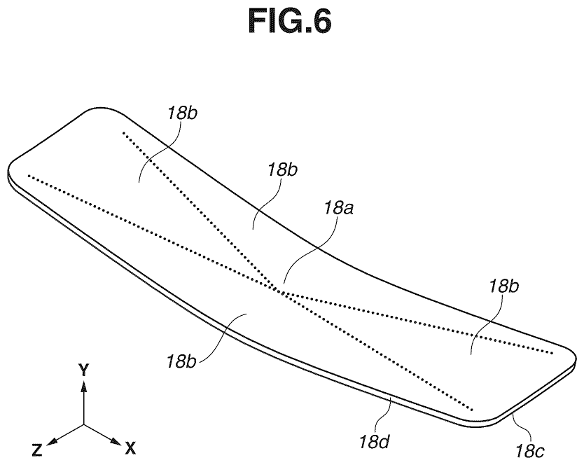

FIG. 4 is a cross-sectional perspective view of the toner cartridge C. FIG. 5 is an exploded cross-sectional perspective view of the toner cartridge C. FIG. 6 is a perspective view of the ventilation member (filter) 18.

In FIGS. 3A, 3B, and subsequent drawings, arrows X and Y or arrows X, Y, and Z illustrated in a lower part thereof indicate a horizontal lateral direction as an X direction, a direction of gravity as a Y direction, and a horizontal depth direction as a Z direction, in a state where the toner cartridge C is mounted to the apparatus main body A.

The outline of the overall configuration of the toner cartridge C is described herein. As illustrated in FIG. 3A, the toner cartridge C stores the toner T to be supplied to the process cartridge B and is partitioned into a toner storage portion 16 and an air chamber 17 by the sheet-like ventilation member 18. The toner storage portion 16 is provided with a discharge path 27, and the air chamber 17 is provided with an air supply port 20.

As illustrated in FIG. 4, the toner cartridge C includes a first frame 31 and a second frame 32. The ventilation member 18 is arranged and fixed between the first frame 31 and the second frame 32.

Next, an assembly order of the ventilation member 18, the first frame 31, and the second frame 32 is described with reference to FIG. 5. The first frame 31 is provided with a support portion 31a. The support portion 31a is located inside an inner wall 31b of the first frame 31 and is provided over an entire periphery in the horizontal direction (X and Z directions). The ventilation member 18 is assembled to the first frame 31 downward from above in the direction of gravity (Y direction) and is supported by an abutment surface 31f of the support portion 31a. A portion where the ventilation member 18 is supported by the support portion 31a is an outer edge portion of the ventilation member 18.

The second frame 32 is assembled to the first frame 31 and the ventilation member 18 in a downward direction, i.e. from above in the direction of gravity (Y direction). Configurations for adhering the ventilation member 18, the first frame 31, and the second frame 32 according to the present exemplary embodiment is described in detail below.

The ventilation member 18 is described with reference to FIG. 6. As illustrated in FIG. 6, the ventilation member 18 is formed of an inclined portion 18b inclined toward a lowermost portion 18a, a lower surface portion 18c, and an adhesion surface 18d (a hatched portion, a third surface) that connects the inclined portion 18b and the lower surface portion 18c.

Here, the ventilation member 18 is a porous member made of, for example, a resin fiber, with pores of a size and density that allow air to pass therethrough but that does not allow the toner T to pass therethrough. The ventilation member 18 according to the present exemplary embodiment is made of a filter material that is molded by thermal pressing or the like. The ventilation member 18 may be formed to have a thickness of 0.8 to 1.5 mm, and the ventilation member 18 may be formed in a predetermined shape.

As illustrated in FIG. 3A, the air chamber 17 is a space surrounded by the first frame 31 and the ventilation member 18, having the lower surface portion 18c of the ventilation member 18 as a ceiling surface, and being a single connected space. The first frame 31 forming part of the air chamber 17 is provided with the air supply port 20 that receives air. As illustrated in FIG. 1, when the toner cartridge C is mounted to the apparatus main body A, the air supply port 20 is connected to a pump 35, provided in the apparatus main body A, via an air supply pipe 21. The air chamber 17 is a space having the lower surface portion 18c of the ventilation member 18 as the ceiling surface, and the toner cartridge C is configured to be detachably mountable to the image forming apparatus IF. Thus, in a posture in which the toner cartridge C is mounted to the apparatus main body A of the image forming apparatus IF, the air chamber 17 is a space with the lower surface portion 18c of the ventilation member 18 as the ceiling surface in the direction of gravity.

The discharge path (pipe) 27 is described with reference to FIG. 4, illustrating the discharge path 27 as a tubular passage that connects the toner storage portion 16 and the outside of the toner cartridge C, with its interior communicating therebetween. One end of the discharge path 27 is an inflow port (suction port) 27a, which is provided in the toner storage portion 16 (toner storage chamber), through which the toner flows in (the toner is sucked in). The other end thereof is the discharging port 27b leading outside of the toner cartridge C. As the discharge path 27, a hollow member such as a flexible tube made of rubber, silicon, or the like, or a pipe made of resin or metal may be appropriately selected.

The inflow port 27a is directed downward to face the ventilation member 18, and the ventilation member 18 extends downward toward the inflow port 27a. The inflow port 27a is positioned closer to the center of the ventilation member 18 than to the outer edge portion thereof, and extends in the direction of gravity.

As illustrated in FIG. 3A, the discharging port 27b is provided with the sealing member 30. In a state where the toner cartridge C is a single unit, the sealing member 30 seals the discharging port 27b to prevent the toner T in the toner storage portion 16 from leaking to the outside. If the toner cartridge C is mounted to the apparatus main body A, as illustrated in FIG. 3B, the sealing member 30 moves to a position at which the discharging port 27b is opened. In a state where the toner cartridge C is mounted to the apparatus main body A, as illustrated in FIG. 2, the discharging port 27b communicates with the receiving port 24 of the process cartridge B, and the toner T in the toner cartridge C can be supplied to the process cartridge B.

As illustrated in FIG. 3A, the toner storage portion 16 is a space surrounded by the second frame 32 and the inclined portion 18b of the ventilation member 18 as a bottom surface thereof, and stores the toner T.

As illustrated in FIG. 4, the second frame 32 includes an inflow port support portion 32a that supports a vicinity of the inflow port 27a of the discharge path 27 inside the toner storage portion 16. The second frame 32 also includes a discharging port support portion 32b that supports the discharging port 27b of the discharge path 27.

According to the present exemplary embodiment, the configuration of the toner cartridge is described, but the exemplary embodiment of the present disclosure is not limited thereto and can be applied to a cartridge with an all-in-one configuration in which the toner cartridge C and the process cartridge B are integrated, and a toner chamber of a cartridge in which the toner cartridge C and a developing unit are integrated.

### (Toner Discharge Mechanism)

Next, a mechanism by which the toner T is discharged from the toner cartridge C and supplied to the process cartridge B is described with reference to FIGS. 1, 2, 3A, and 3B.

According to the present exemplary embodiment, as illustrated in FIG. 1, the toner T is conveyed from the toner storage portion 16 to the outside of the toner cartridge C and is supplied to the process cartridge B only by a pushing force generated by air that is discharged by the pump 35 provided in the apparatus main body A and that flows in from the air supply port 20.

The pump 35 may be appropriately selected from among a reciprocating pump, a diaphragm pump, a rotary pump, and the like. The pump 35 is connected to the air supply port 20 of the air chamber 17 via the air supply pipe 21. Air discharged from the pump 35 is sent to the air chamber 17 through the air supply port 20 of the toner cartridge C as illustrated in FIGS. 3A and 3B. Then, the air flows into every corner of the air chamber 17, which is a single space, and flows to the ventilation member 18 that forms the ceiling surface. Next, the air passes through the ventilation member 18 and flows into the toner storage portion 16. The air flowing into the toner storage portion 16 fluidizes the toner T in the toner storage portion 16.

Then, as illustrated in FIG. 2, the air mixed with the toner T passes through the inflow port 27a and the discharge path 27 and is discharged from the discharging port 27b. The discharged air and toner T is supplied to the process cartridge B through the receiving port 24. At this time, not only the toner T but also the air flows into the toner chamber 12 of the process cartridge B, and an internal pressure of the toner chamber 12 increases momentarily. However, as described above, the air can be released from the exhaust portion 26 provided on the upper surface of the toner chamber 12, so that the internal pressure of the toner chamber 12 can be prevented from increasing.

As illustrated in FIG. 1, the pump 35 according to the present exemplary embodiment is provided in the apparatus main body A, but a configuration in which the pump 35 is provided in the process cartridge B or the toner cartridge C may also be employed.

### (Joint Structure of Ventilation Member and Frames)

A joint structure of the ventilation member 18, the first frame 31, and the second frame 32 is described with reference to FIGS. 5, 7A to 7C, 8A, and 8B.

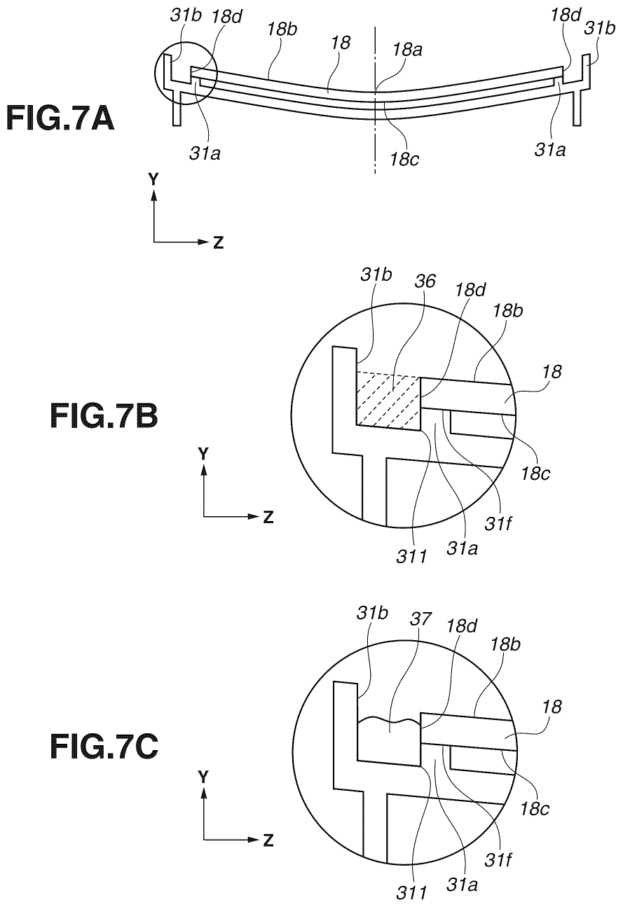

FIG. 7A is a cross-sectional view illustrating a state where the ventilation member 18 is supported by the first frame 31, and FIGS. 7B and 7C are detailed drawings of the joint structure. Here, the description is provided using a Y-Z cross section, with the joint structure having a similar shape in an X-Z cross section. First, from a process of assembling the ventilation member 18 to the first frame 31 to a process of applying an adhesive member 37 are described with reference to FIGS. 7A to 7C.

As illustrated in FIG. 7A, the first frame 31 is provided with the support portion 31a that protrudes in the Y direction. When the ventilation member 18 is assembled to the first frame 31, the ventilation member 18 is supported by the support portion 31a in the direction of gravity (Y direction).

Accordingly, as illustrated in FIG. 7B, an adhesive member holding portion 36 (hatched area with dashed lines, which may also be referred to as an adhesive holding portion) is formed over an entire periphery in the horizontal direction (X and Z directions) by the adhesion surface 18d on a side surface of the ventilation member 18, an outer wall 311 of the support portion 31a, and the inner wall 31b of the first frame 31. The outer wall 311 of the support portion 31a and the adhesion surface 18d of the ventilation member 18 are configured to be on substantially the same surface in the horizontal direction (X and Z directions). The support portion 31a has the outer wall 311 that is fixed by the adhesive member 37 on a side opposite to the center of the ventilation member 18 with respect to the abutment surface 31f that abuts the ventilation member 18. In this way, the first frame 31 has a groove shape that opens upward, and the adhesive member holding portion 36 is configured to be surrounded by the first frame 31 and the ventilation member 18.

Subsequently, an adhesive member application apparatus injects and applies the adhesive member 37 to the adhesive member holding portion 36, as illustrated in FIG. 7C. Accordingly, the first frame 31 and the ventilation member 18 are joined via the adhesive member 37. Here, a hot melt, which is a thermoplastic adhesive member, is applied as the adhesive member 37.

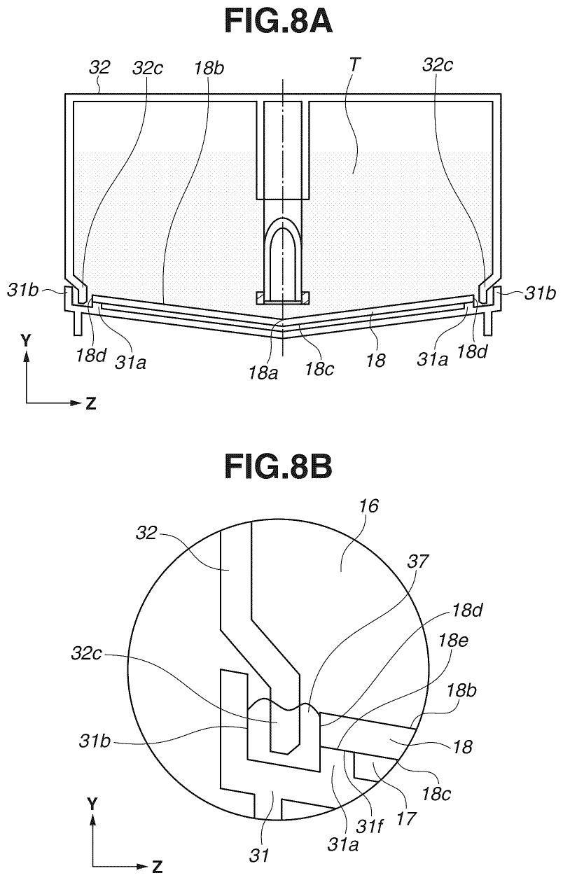

Configurations for joining the second frame 32 and the first frame 31 are described with reference to FIGS. 5, 8A, and 8B. FIG. 8A is a cross-sectional view illustrating a state in which the ventilation member 18, the first frame 31, and the second frame 32 are joined together, and FIG. 8B is a detailed view of the joint structure.

The adhesive member 37 is applied to the first frame 31 to which the ventilation member 18 is assembled, and then the second frame 32 is assembled to the first frame 31 downward from above in the direction of gravity (Y direction), as described above.

As illustrated in FIG. 5, the second frame 32 has a protruding portion 32c over an entire periphery in the horizontal direction (X and Z directions), with the protruding portion 32c being provided at a position corresponding to the adhesive member holding portion 36. The protruding portion 32c refers to a portion of the second frame 32 that protrudes toward the first frame 31 by being adhered to the first frame 31, as described below.

As illustrated in FIG. 8B, the protruding portion 32c of the second frame 32 is inserted into the adhesive member 37 applied to the adhesive member holding portion 36. Subsequently, the hot melt, which is the adhesive member 37, is thermally cured, and thus the second frame 32 is adhered and fixed to the first frame 31 and the ventilation member 18 via the adhesive member 37 (the protruding portion 32c may be referred to as a fixing portion).

Insertion of the protruding portion 32c of the second frame 32 displaces the adhesive member 37 upward in the direction of gravity (Y direction) in an amount corresponding to a volume of the protruding portion 32c. If the entire adhesive member holding portion 36 is stably filled with the adhesive member 37, the ventilation member 18 and the first frame 31 can be stably joined together. An upper portion of the adhesion surface 18d in the direction of gravity (Y direction) is also configured to be a part of the toner storage chamber (toner storage portion) 16.

In a posture in which the toner cartridge C is mounted to the apparatus main body A of the image forming apparatus IF, a direction in which the first frame 31 and the second frame 32 are aligned is the direction of gravity (first direction). In other words, a direction in which the protruding portion 32c of the second frame 32 is provided is the horizontal direction, and among horizontal directions, the X direction is a second direction, and the Z direction is a third direction in the drawings.

### (Effect of Joint Structure)

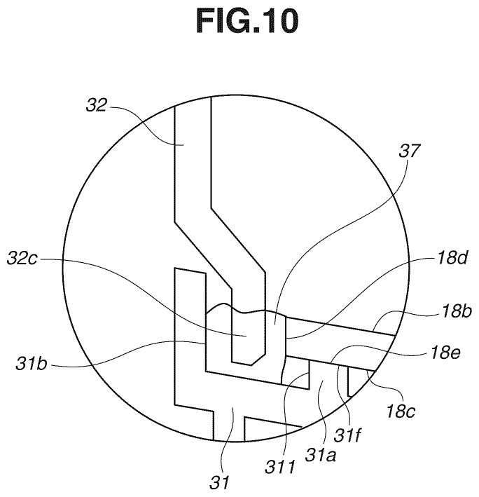

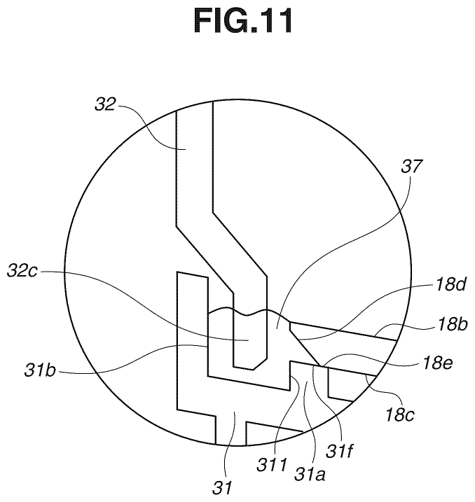

An effect of the joint structure according to the first exemplary embodiment is described with reference to FIGS. 8A, 8B, 9, 10, and 11. FIGS. 10 and 11 are cross-sectional views of modifications having different configurations from that in FIGS. 8A and 8B, illustrating a state in which the ventilation member 18, the first frame 31, and the second frame 32 are joined together.

To reduce an amount of residual toner in the toner cartridge C, the ventilation member 18, the first frame 31, and the adhesive member 37 may be configured in a state illustrated in FIG. 8B. In this state, a supported portion 18e of the ventilation member 18 abuts the support portion 31a of the first frame 31 and only the adhesion surface 18d is in contact with the adhesive member 37.

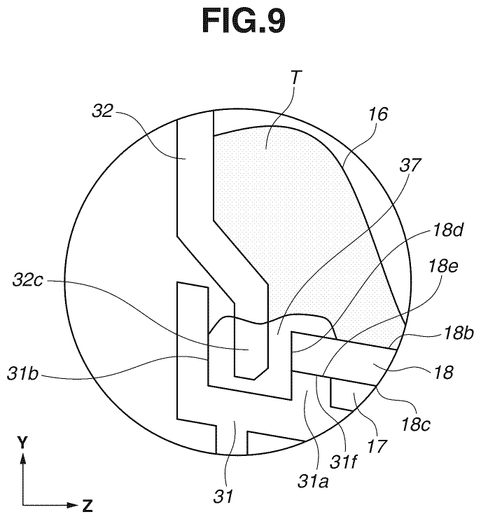

If, as illustrated in FIG. 9, the adhesive member 37 overflows and is applied to not only the adhesion surface 18d but also to a portion of the inclined portion 18b, a phenomenon occurs in which air is supplied to the air chamber 17 and passes through the ventilation member 18, but the air is less likely to pass through the portion of the inclined portion 18b where the adhesive member 37 is applied, due to the adhesive member 37 that covers the surface thereof. Thus, the toner T on the inclined portion 18b onto which the adhesive member 37 is applied is difficult to be fluidized, resulting in an increase in the residual toner amount.

Thus, to achieve the effect of reducing the residual toner amount, a state in which the adhesion surface 18d of the ventilation member 18 is in contact with the adhesive member 37 is to be established. Accordingly, there is no portion that blocks the air passing through the ventilation member 18 on the inclined portion 18b, so that the toner T in the toner storage chamber 16 can be fluidized more reliably. As a result, it is possible to prevent the phenomenon in which the surface of the inclined portion 18b is covered with the adhesive member 37, making it difficult for air to pass therethrough. In other words, the three components, i.e., the first frame 31, the second frame 32, and the ventilation member 18 can be joined together without any gap, and the residual toner amount can be reduced.

Here, it can be said that the ventilation member 18 is fixed to the first frame 31 with the adhesive (the adhesive member 37) at a first portion (the adhesion surface 18d) between a surface (first surface) on the air chamber 17 side and a surface (second surface) on the toner storage chamber 16 side. The air passes through the ventilation member 18 from the surface (first surface) on the air chamber 17 side to the surface (second surface) on the toner storage chamber 16 side.

Here, the adhesion surface 18d is configured to surround the first surface and the second surface when viewed from the first direction in which the first frame 31 and the second frame 32 are aligned.

An upper surface of the support portion 31a abuts the supported portion 18e of the ventilation member 18 without an adhesive interposed therebetween. Thus, air passes between the upper surface of the support portion 31a and the supported portion 18e of the ventilation member 18. Accordingly, the toner T on the inclined portion 18b in the portion above an abutting portion is fluidized, and residual toner is less likely to remain above the abutting portion. In attaching and assembling the ventilation member 18, the support portion 31a supports the ventilation member 18. Thus, there is an effect of eliminating a need of a holding unit for maintaining a position of adhesion.

In the first exemplary embodiment, the support portion 31a and the adhesion surface 18d are configured to be on the same surface. However, as illustrated in FIG. 10, the adhesion surface 18d of the ventilation member 18 may protrude from the outer wall 311 of the support portion 31a toward the adhesive member holding portion 36 and adhesive member 37, to increase the adhesion surface. A portion of the ventilation member 18 in contact with the adhesive member 37 increases by an amount that the ventilation member 18 protrudes toward the adhesive member holding portion 36, so that joint strength to the ventilation member 18 can also be increased.

As illustrated in FIG. 11, to increase an adhesive area of the ventilation member 18 to the adhesive member 37 on a cross section, a part of the ventilation member may be chamfered to form the adhesion surface 18d, with the chamber having an inclined surface (fourth surface). With this configuration as well, the portion that comes into contact with the adhesive member 37 is increased, and the joint strength to the ventilation member 18 can be increased. Here, a portion having the inclined surface is an inclined surface (second adhesion surface) that intersects but is not perpendicular to the surface (first surface) on the air chamber 17 side and the surface (second surface) on the toner storage chamber 16 side.

The adhesive member 37 is not limited to the hot melt and may be an adhesive member such as a silicone bond. The ventilation member 18 may be formed of a material molded by thermal pressing as well as by other methods, such as a nonwoven fabric or a sintered material.

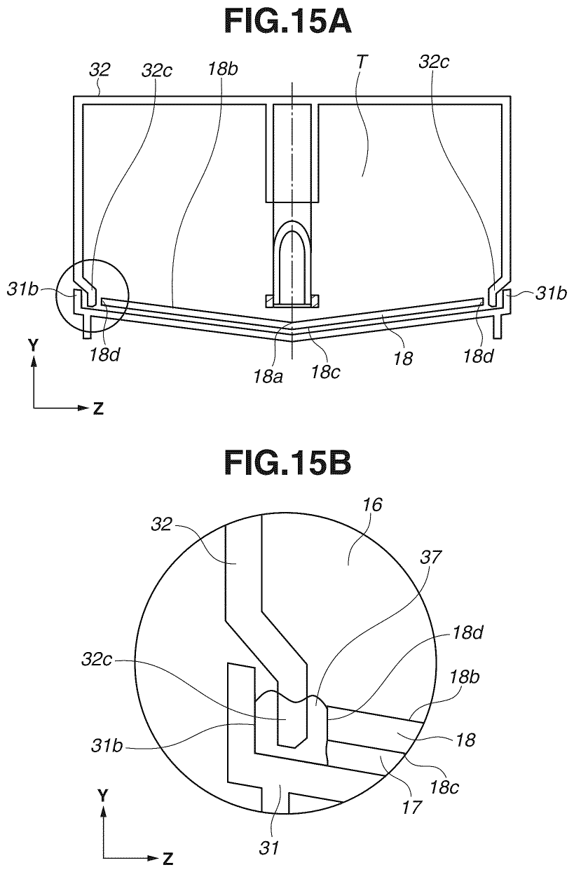

Since it is sufficient that only the adhesion surface 18d of the ventilation member 18 is in contact with the adhesive member 37, a configuration without a support portion may be used, as illustrated in FIGS. 15A and 15B. In assembling, the ventilation member 18 is temporarily supported at a predetermined position by a jig or tool, and the adhesive member 37 is applied thereto and cured while maintaining the predetermined position. By such assembly, it is possible to bring only the adhesion surface 18d of the ventilation member 18 into contact with the adhesive member 37 even without a support portion.

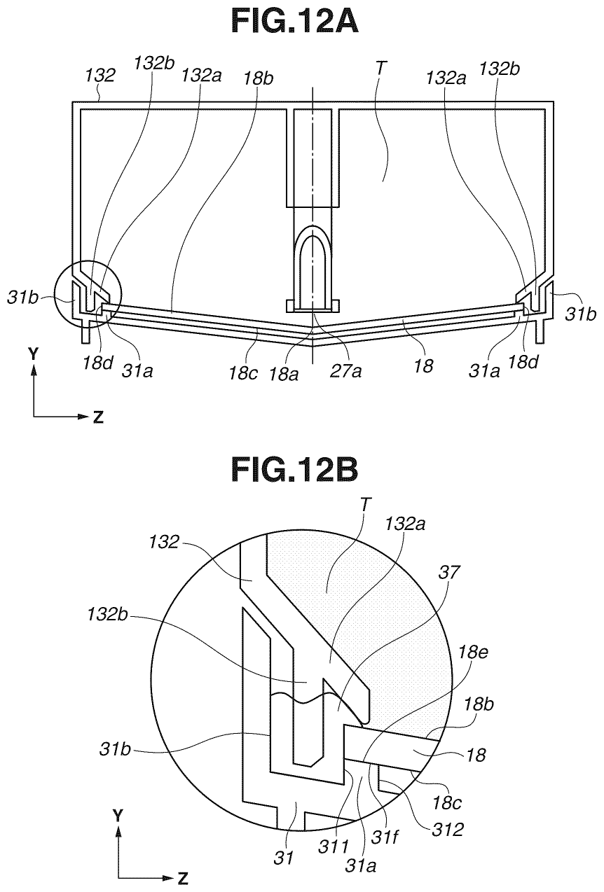

A configuration according to a second exemplary embodiment represents a modification of the second frame 32 of the first exemplary embodiment. The configuration according to the second exemplary embodiment is described with reference to FIGS. 12A and 12B.

FIG. 12A is a cross-sectional view of a second frame 132 at the time of joining, and FIG. 12B is a detailed view of the joint structure. Here, the description is provided using the Y-Z cross section, with the X-Z cross section having a similar shape.

Configurations for assembling the first frame 31, the second frame 132, and the ventilation member 18 are the same as those according to the first exemplary embodiment, and the description is incorporated by reference here, for conciseness.

As illustrated in FIG. 12A, the second frame 132 is provided with a regulating portion 132a that regulates the adhesive member 37. The regulating portion 132a is arranged outside an inner wall 312 on the side where the inflow port 27a is located in the horizontal direction (X and Z directions), and a space above the regulating portion 132a in the direction of gravity (Y direction) is configured as the toner storage portion 16. As illustrated in FIG. 12B, the regulating portion 132a has an inclined surface and is configured such that the distance from the ventilation member 18 in the direction of gravity (Y direction) is reduced toward the inflow port 27a. Accordingly, even if a protruding portion 132b of the second frame 132 is inserted into the adhesive member 37 and the surface of the adhesive member 37 rises, such a configuration with the regulating portion 132a makes it difficult for the adhesive member 37 to flow into the toner storage portion 16. This is because a flow of the adhesive member 37 before curing is regulated by such configuration.

An angle of the inclined surface of the regulating portion 132a is larger than an angle of repose of the toner. Accordingly, the toner T in a region above the adhesive member 37 where the air passing through the ventilation member 18 is not sent can be collected to the side of the inflow port 27a by the inclined surface shape. In other words, the toner T in the region above the adhesive member 37 can be collected on the ventilation member 18 through which the air can pass. By being collected on the ventilation member 18, the toner T can be fluidized by the air passing through the ventilation member 18 and can flow into the toner storage portion 16, and can be collected to the side of the inflow port 27a by the inclined portion 18b. As a result, the amount of residual toner can be further reduced.

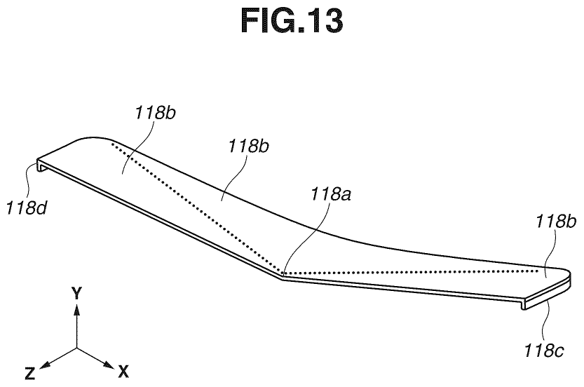

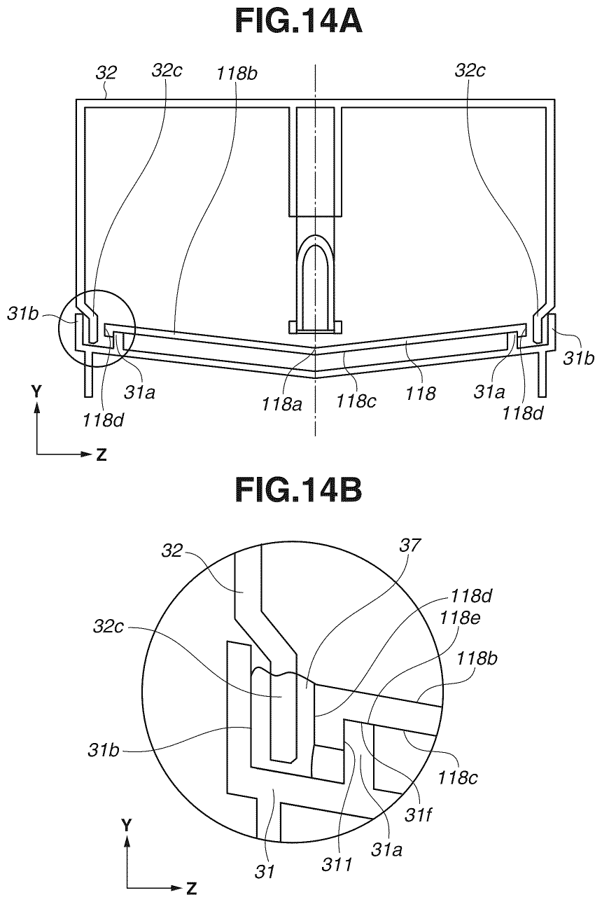

Next, a configuration according to a third exemplary embodiment of the present disclosure is described with reference to FIGS. 13, 14A, and 14B. The configuration according to the present exemplary embodiment is a modification of a shape of the adhesion surface 18d according to the first exemplary embodiment.

FIG. 13 is a cross-sectional perspective view of a ventilation member 118 according to the present exemplary embodiment. FIG. 14A is a cross-sectional view of the second frame 32 at the time of joining, and FIG. 14B is a detailed view of the joint structure. Here, the description is provided using the Y-Z cross section, with the joint structure having a similar shape in the X-Z cross section.

Similar to the first exemplary embodiment, the ventilation member 118 includes an inclined portion 118b inclined toward a lowermost portion 118a, and a lower surface portion 118c, and a part of a surface that connects the inclined portion 118b and the lower surface portion 118c of the ventilation member 118 is an adhesion surface 118d. The adhesion surface 118d has a shape protruding downward in the direction of gravity (Y direction), and the adhesion surface 118d is provided over the entire periphery in the horizontal direction (X and Z directions).

Next, the joint structure of the first frame 31, the second frame 32, and the ventilation member 118 is described with reference to FIGS. 14A and 14B. Configurations for assembling the first frame 31, the second frame 32, and the ventilation member 118 are the same as those according to the first exemplary embodiment, and the description thereof is incorporated by reference here, for conciseness.

As illustrated in FIGS. 14A and 14B, in the horizontal direction (X and Z directions), an edge portion of the ventilation member 118 is bent toward a direction intersecting the first surface and the second surface to form the adhesion surface 118d. The adhesion surface 118d of the ventilation member 118 is arranged to protrude from the outer wall 311 of the support portion 31a, and to protrude downward in the direction of gravity (Y direction) beyond a supported portion 118e. Accordingly, it is possible to increase a length of a portion that contributes to adhesion in the direction of gravity (Y direction). In other words, it is possible to increase an adhesive distance that is the length of the portion that contributes to adhesion without reducing the region through which the air can flow from the ventilation member 118 to the toner storage chamber 16, and to make it easier to ensure the joint strength of the ventilation member 118.

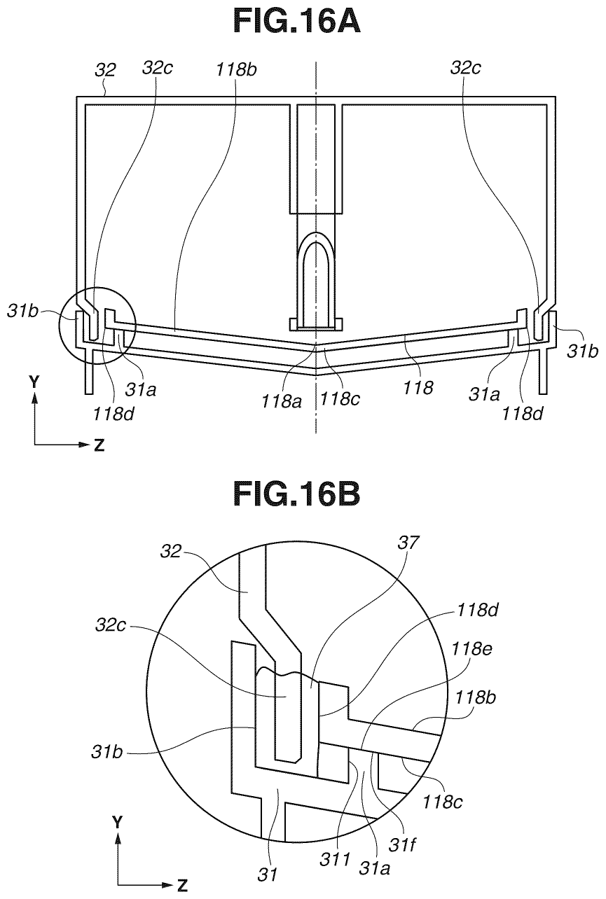

As illustrated in FIGS. 16A and 16B, the adhesion surface 118d may be configured to protrude upward in the direction of gravity (Y direction) beyond the supported portion 118e, contrary to FIGS. 14A and 14B. In the arrangement illustrated in FIGS. 16A and 16B, it is possible to increase the adhesive distance that is the length of the portion that contributes to adhesion without reducing the region through which the air can flow from the ventilation member 118 to the toner storage chamber 16, and to make it easier to ensure the joint strength of the ventilation member 118.

The ventilation member 118 according to the third exemplary embodiment may be combined with the configuration according to the second exemplary embodiment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-113440, filed Jul. 16, 2024, which is hereby incorporated by reference herein in its entirety.

What is claimed is:

1. A toner cartridge comprising:
a first frame provided with a receiving port configured to receive air from outside the toner cartridge;
a second frame;
a space between the first frame and the second frame; and
a filter configured to partition the space into an air chamber and a toner storage chamber that stores toner, and to regulate passage of toner while allowing passage of the air,
wherein the air chamber communicates with the receiving port without interposition of the filter,
wherein the toner storage chamber communicates with the receiving port through the filter,
wherein the filter includes a first surface that faces the air chamber, a second surface that faces the toner storage chamber, and a third surface that extends in a thickness direction of the filter and connects the first surface and the second surface, and
wherein at least a part of the third surface is adhered to the first frame with an adhesive.

2. The toner cartridge according to claim 1,
wherein the toner cartridge is configured to be detachably mountable to an image forming apparatus, and
wherein, in a case where the toner cartridge is mounted to an apparatus main body of the image forming apparatus, the toner storage chamber is positioned above the air chamber.

3. The toner cartridge according to claim 2, wherein, in a case where the toner cartridge is mounted to the apparatus main body, the third surface extends upward toward an outer edge portion of the filter.

4. The toner cartridge according to claim 1, further comprising:
a discharging port configured to discharge toner together with air from the toner storage chamber to the outside of the toner cartridge; and
a pipe provided in the toner storage chamber, the pipe including a suction port communicating with the discharging port for suctioning toner from inside the toner storage chamber,
wherein, in a case where a direction in which the first frame and the second frame are aligned is defined as a first direction, a direction orthogonal to the first direction is defined as a second direction, and a direction orthogonal to the first direction and the second direction is defined as a third direction, when the first direction is a direction of gravity and the toner storage chamber is positioned above the air chamber, the suction port faces downward and faces the filter, and when viewed in the second direction, the filter extends downward toward the suction port.

5. The toner cartridge according to claim 4, wherein, in the first direction, the suction port is closer to a center of the filter than to an outer edge of the filter.

6. The toner cartridge according to claim 4,
wherein, the filter is formed as a sheet,
wherein, in a case where the toner cartridge is mounted to an apparatus main body of an image forming apparatus, the first frame includes a support portion that protrudes toward the filter and is configured to support the filter from below at an outer edge portion of the filter, with an abutment surface configured to abut a surface of the filter on a side of the first surface, when viewed in the second direction, and
wherein the support portion includes an outer wall to which the filter is fixed via the adhesive on an opposite side to a center of the filter with respect to the abutment surface in the third direction.

7. The toner cartridge according to claim 6,
wherein, in the case where the toner cartridge is mounted to the apparatus main body, the first frame includes an adhesive holding portion that has a groove shape opening upward and is formed of the first frame and the filter, and
wherein the outer wall and the third surface constitute a part of the adhesive holding portion.

8. The toner cartridge according to claim 7, wherein, in the case where the toner cartridge is mounted to the apparatus main body, the second frame includes a fixing portion that extends downward and is configured to be inserted into the adhesive holding portion and fixed with the adhesive.

9. The toner cartridge according to claim 4,
wherein, in a case where the toner cartridge is mounted to an apparatus main body of an image forming apparatus, the first frame includes a support portion that protrudes toward the filter and is configured to support the filter from below at an outer edge portion of the filter, with an abutment surface configured to abut a surface of the filter on a side of the first surface, when viewed in the second direction,
wherein, in a case where the toner cartridge is mounted to the apparatus main body, the second frame includes a fixing portion that extends downward and that is fixed to the first frame with the adhesive, and
wherein the third surface is provided between the support portion and the fixing portion in the third direction.

10. The toner cartridge according to claim 8,
wherein, when viewed in the second direction, the second frame includes a regulating portion extending downward in the third direction toward the suction port, and
wherein the regulating portion is configured to regulate a flow of the adhesive before curing.

11. A toner cartridge comprising:
a first frame provided with a receiving port configured to receive air from outside the toner cartridge;
a second frame;
a space between the first frame and the second frame; and
a filter configured to partition the space into an air chamber and a toner storage chamber that stores toner, and to regulate passage of toner while allowing passage of the air,
wherein the air chamber communicates with the receiving port without interposition of the filter,
wherein the toner storage chamber communicates with the receiving port through the filter,
wherein the filter includes a first surface that faces the air chamber, a second surface that faces the toner storage chamber, and a third surface that is formed by bending an edge portion of the first surface or the second surface in a direction intersecting the first surface and the second surface, and
wherein at least a part of the third surface is adhered to the first frame with an adhesive.

12. The toner cartridge according to claim 11,
wherein the toner cartridge is configured to be detachably mountable to an image forming apparatus, and
wherein, in a case where the toner cartridge is mounted to an apparatus main body of the image forming apparatus, the third surface is provided to protrude downward.

13. The toner cartridge according to claim 10, wherein, the filter is formed as a sheet.
